(19) United States
(12) Patent Application Publication
(10) Pub. No.: US 2014/0253328 A1
(43) Pub. Date: Sep. 11, 2014

(54) HAZARD WARNING APPARATUS AND SYSTEM AND METHOD FOR USE THEREOF

(71) Applicant: Jessel Craig, Pembroke Pines, FL (US)

(72) Inventor: Jessel Craig, Pembroke Pines, FL (US)

(21) Appl. No.: 14/286,141

(22) Filed: May 23, 2014

(51) Int. Cl. G08B 21/02

(52) U.S. Cl. CPC G08B 21/02
USPC 340/540

(57) ABSTRACT

Embodiments of the present invention are generally directed towards hazard communication and alarm systems. Specifically, embodiments of the present invention are configured to provide a hazard or disaster warning apparatus configured to work independently or in conjunction with security cameras and/or an existing hazard detection and/or communication system in order to provide one or more of an audio or visual hazard alert. Certain embodiments of the present invention provide for exit path or other path routing capabilities during emergency and/or disaster recovery operations. Further embodiments of the present invention may be integrated with one or more security components (e.g., hazard sensors, anti-theft sensors).

### FIELD OF THE INVENTION

Embodiments of the present invention are generally directed towards hazard communication and alarm systems. Specifically, embodiments of the present invention are configured to provide a hazard or disaster warning apparatus configured to work independently or in conjunction with security cameras and/or an existing hazard detection and/or communication system in order to provide one or more of an audio or visual hazard alert. Certain embodiments of the present invention provide for exit path or other path routing capabilities during emergency, disaster recovery operations and/or other appropriate scenarios. Further embodiments of the present invention may be integrated with one or more security components (e.g., hazard sensors, anti-theft sensors).

### BACKGROUND

Current hazard detection, communication and warning systems generally are developed with a centralized processing and command unit that receives information from one or more sensors and provides alerts in an unspecific, untargeted and relatively generic manner. A common embodiment of this approach is a residential or commercial anti-theft system, wherein one or more sensors (e.g., glass break sensor, door/window sensor, smoke detector) connect to a centralized alarm panel or other control unit and alerts are generally provided by a loud speaker in the form of a loud beeping provided at high decibels in order to deter or scare off intruders. Similar concepts are used for specific hazard detection, communication and warning systems (e.g., fire alarm systems, carbon monoxide hazard systems, earthquake detection systems).

Other types of hazard detection systems currently utilized are unsophisticated means, such as security cameras which simply record or otherwise provide a video feed. These systems generally provide raw data to a monitor, digital or analog recording system, or other display or recording means for the provision of visual data. Some of these systems may be set to be activated by attached sensors (e.g., motion sensors), but none are equipped to provide audio and visual hazard alerts and warnings to those in the vicinity of the standalone camera.

Several problems arise with these current approaches to alarm, hazard detection and/or, hazard communication systems (herein referred to collectively as “hazard communications systems”). A first problem, with respect to those hazard communication systems that provide an audible alert, is that by using a generic audible alert, individuals in the hazard area are only alerted to the presence of a non-specific hazard. Individuals may need to take various approaches to ensure safety of themselves and others depending on the type of hazard and a non-specific hazard alert does nothing to help the individual determine a type or severity of the detected hazard. For instance, individuals may take completely different actions depending on whether a hazard is a break-in or the hazard is a fire.

A second problem with current hazard communication systems is that they generally rely on a central processing and command unit (hereinafter, “command unit”) to receive and provide information to the various components of the system (e.g., sensors, cameras). If a command unit fails, the entire system fails. Even where a sensor may be tripped and an alert should be activated in response, if the command unit fails, no alert occurs. This single and central point of failure is a significant concern with current hazard communication systems.

Further, with the simplistic hazard communication systems, such as standalone security cameras, there is no hazard communication or external alert/warning mechanism. There may be a simple on/off detection made by an associated motion detector or other simple detection system, but there is no alert or other warning system available thereto.

Considering that these current hazard communication systems, including simple security camera systems, are ubiquitous and are in operation in numerous settings in all manners of fields and services, replacing every current system is an undesired approach to correcting these failures of the current art. It would be more desirable to be able to supplement the current systems with one or more apparatuses that could correct the aforementioned deficiencies without requiring for replacement of the entire hazard communication system.

Therefore, there is need in the art for a hazard warning apparatus that may work as a standalone hazard warning apparatus or in conjunction with existing security cameras, hazard detection and/or communication systems for the purpose of providing dynamic hazard warnings and specific information related thereto, and a system and method for use thereof. These and other features and advantages of the present invention will be explained and will become obvious to one skilled in the art through the summary of the invention that follows.

### SUMMARY OF THE INVENTION

Accordingly, it is an aspect of the present invention to provide a hazard warning apparatus that may work as a standalone hazard warning apparatus or in conjunction with existing security cameras, hazard detection and/or communication systems for the purpose of providing dynamic hazard warnings and specific information related thereto, and a system and method for use thereof. The following is a summary for providing a solution to the problem in the form of a hazard warning apparatus configured to provide an hazard alert based on criteria and data available to and processed by the apparatus and any attached components thereto.

According to an embodiment of the present invention, a hazard warning apparatus includes: an illumination component; one or more audio units; and a control element comprising a processing means, a memory storage medium, a communications module, one or more interface ports and one or more media ports, wherein said illumination component, said one or more audio units and said control element are operably connected and are configured to: receive hazard data from one or more of said one or more interface ports and said communications module; process said hazard data; generate hazard response data based on said hazard data; generate a hazard alert via said illumination component and said one or more audio units.

According to an embodiment of the present invention, the illumination component, said one or more audio units and said control element are further configured to: receive real-time hazard response data via one or more of said one or more interface ports and said communications module.

According to an embodiment of the present invention, the real-time hazard response data is processed and a real-time hazard alert is generated via said illumination component and said one or more audio units.

According to an embodiment of the present invention, the illumination component is comprised of a plurality of illumination sources.

According to an embodiment of the present invention, the hazard alert comprises a visually perceptible illumination of an appropriate exit pathway via said illumination component.

According to an embodiment of the present invention, the hazard alert comprises an audibly perceptible sound defining an appropriate exit pathway via said one or more audio units.

According to an embodiment of the present invention, the hazard warning apparatus further includes one or more sensors.

According to an embodiment of the present invention, each of said one or more sensors is operably connected to said control element via one or more of said one or more interface ports and communications module.

According to an embodiment of the present invention the hazard warning apparatus further includes one or more communication means including but not limited to, WiFi communication means, BLUETOOTH communication means, Ethernet communication means, Cellular Data communication means, Near Field Communications means and Radio Frequency communication means.

According to an embodiment of the present invention, the hazard warning apparatus further includes one or more switches.

According to an embodiment of the present invention, the switches are operably connected to said control component and configured to allow for the manual generation of a hazard alert.

According to an embodiment of the present invention, the apparatus is further configured to: receive, via one or more of said communications module and one or more of said one or more interface ports, hazard information from one or more of a security camera, a hazard detection system, or a communication system; and utilize said hazard information to provide one or more of an audio or visual hazard alert.

According to an embodiment of the present invention, a method for generating hazard alerts via a hazard warning apparatus, the method comprising the steps of: receiving hazard data at said hazard warning apparatus via one or more of an interface port and a communications module; processing said hazard data via a control element; generating hazard response data at said control element based on said hazard data; and generating a hazard alert via an illumination component and one or more audio units operably connected to said control element.

According to an embodiment of the present invention, the method further includes the step of receiving real-time hazard response data via one or more of said interface port and said communications module.

According to an embodiment of the present invention, the method further includes the steps of: processing said real-time hazard response data; and providing a real-time hazard alert via said illumination component and said one or more audio units.

According to an embodiment of the present invention, the method further includes the use of a communications module selected from the group comprising WiFi modules, BLUETOOTH modules, Ethernet modules, cellular data modules, near field communication modules and radio frequency communication modules.

According to an embodiment of the present invention, the method further includes the step of: receiving, via one or more of said communications module and said interface port, hazard information from one or more of a security camera, a hazard detection system, or a communication system; and utilizing said hazard information to provide one or more of an audio or visual hazard alert.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates an exploded view of an exemplary embodiment of a hazard warning apparatus, in accordance with an embodiment of the present invention;

FIG. 1B is a front view of an embodiment of a hazard warning apparatus, in accordance with an embodiment of the present invention is shown;

FIG. 1C, is a side view of an embodiment of a hazard warning apparatus, in accordance with an embodiment of the present invention is shown;

FIG. 1D, is a side view of an embodiment of a hazard warning apparatus, in accordance with an embodiment of the present invention is shown;

FIG. 1E is a front view of an embodiment of a hazard warning apparatus, in accordance with an embodiment of the present invention is shown;

FIG. 1F, is a side view of an embodiment of a hazard warning apparatus, in accordance with an embodiment of the present invention is shown;

FIG. 1G, is a side view of an embodiment of a hazard warning apparatus, in accordance with an embodiment of the present invention is shown;

FIG. 1H, is a perspective view of an illumination and control unit mounting component, in accordance with an embodiment of the present invention is shown;

FIG. 2A illustrates a schematic of a hazard warning apparatus, in accordance with an embodiment of the present invention;

FIG. 2B illustrates a schematic of a hazard warning apparatus, in accordance with an embodiment of the present invention;

FIG. 3 illustrates a schematic of a system for providing hazard warnings via multiple hazard warning apparatuses, in accordance with an embodiment of the present invention;

FIG. 4 is a process flow of an exemplary method in accordance with embodiments of the present invention; and

FIG. 5 is a process flow of an exemplary method in accordance with embodiments of the present invention.

### DETAILED SPECIFICATION

Embodiments of the present invention are generally directed towards hazard communication and alarm systems. Specifically, embodiments of the present invention are configured to provide a hazard or disaster warning apparatus configured to work independently or in conjunction with security cameras and/or an existing hazard detection and/or communication system in order to provide one or more of an audio or visual hazard alert. Certain embodiments of the present invention provide for exit path or other path routing capabilities during emergency and/or disaster recovery operations. Further embodiments of the present invention may be integrated with one or more security components (e.g., hazard sensors, anti-theft sensors).

According to an embodiment of the present invention, a hazard warning apparatus is configured to be integrated with a hazard, emergency or other disaster warning mechanism in order to provide hazard alerts to individuals in proximity of the hazard warning apparatus. In certain embodiments, the apparatus is configured to be integrated as part of a security camera or provided in close proximity to a security camera to allow for communication with individuals in proximity to the security camera. In still further embodiments, the apparatus is integrated with various security or hazard detection and/or communication equipment, including, but not limited to, sensors, alarm switches, panic switches or any combination thereof. In other embodiments, the apparatus is a standalone device capable of hazard detection and warning without integration or input from any additional external components.

According to embodiments of the present invention, a hazard warning apparatus is configured to receive and/or transmit data via one or more communications means, including, but not limited to, Ethernet controllers, Wireless communications controllers (e.g., WIFI controllers, BLUETOOTH controllers, Near Field Communications (NFC) controllers, Radio Frequency Transmission controllers, Cellular controllers), Universal Serial Bus (USB) controllers, fiber optic communications means, or any combination thereof. Data may also be provided across one or more interface ports and pass-through ports connected to existing security systems or hazard communication systems. One of ordinary skill in the art would appreciate that there are numerous communication means that could be utilized with embodiments of the present invention and embodiments of the present invention are contemplated for use with any type of communications means.

In an exemplary embodiment according to the present invention, data may be provided to the apparatus, stored by the apparatus and provided by the apparatus to an associated system across local area networks (LANs) (e.g., office networks, home networks) or wide area networks (WANs) (e.g., the Internet). Information provided across these networks, to and from the apparatus and systems associated with the apparatus may be handled via one or more standard communications protocols, such as transmission control protocol (TCP) or user datagram protocol (UDP), or any combination thereof. One of ordinary skill in the art would appreciate that there are numerous manners in which the system could be configured and embodiments of the present invention are contemplated for use with any configuration.

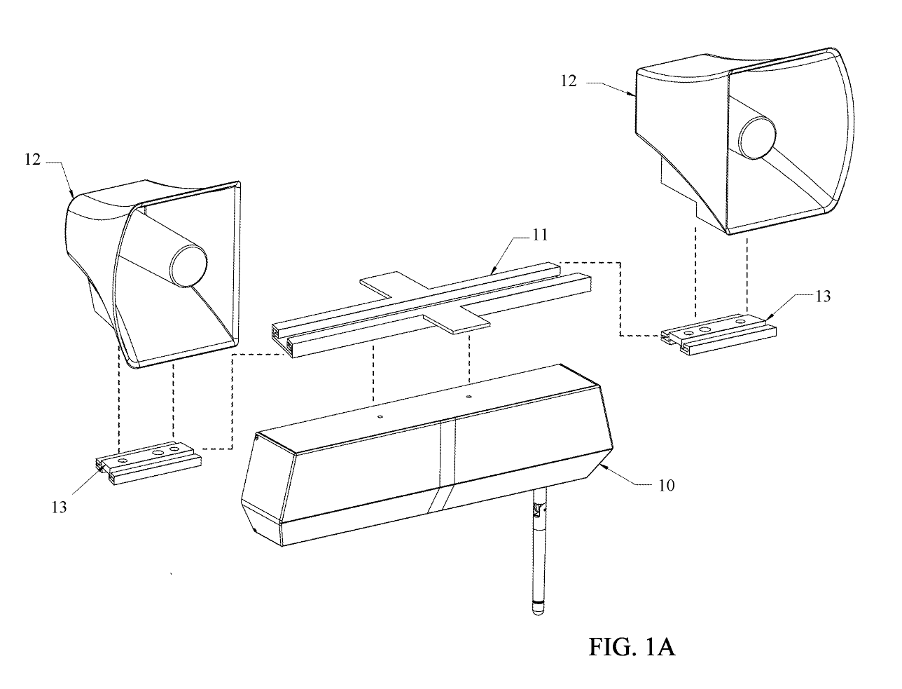

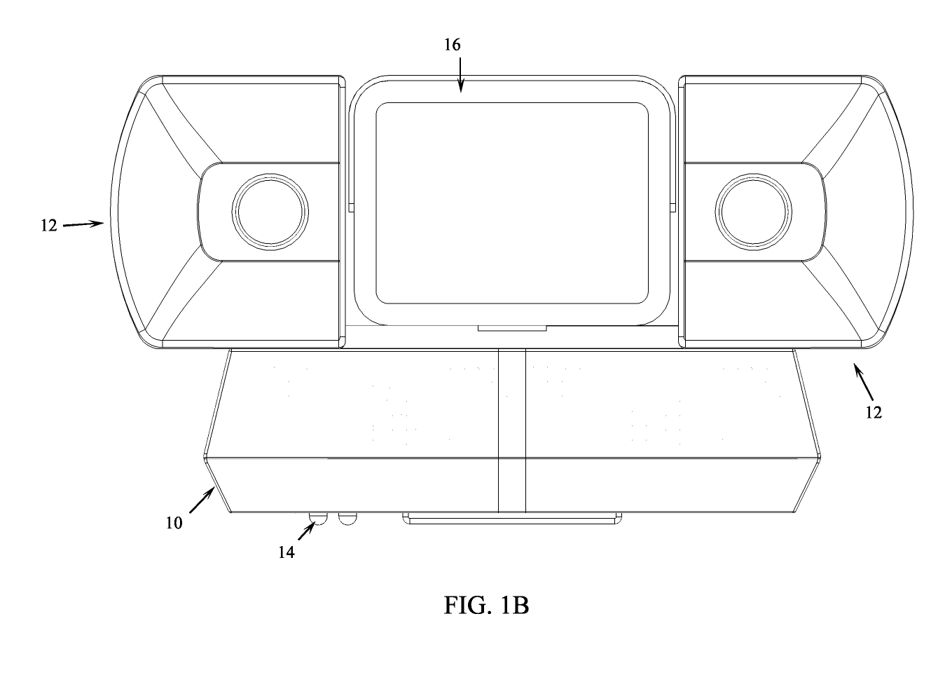

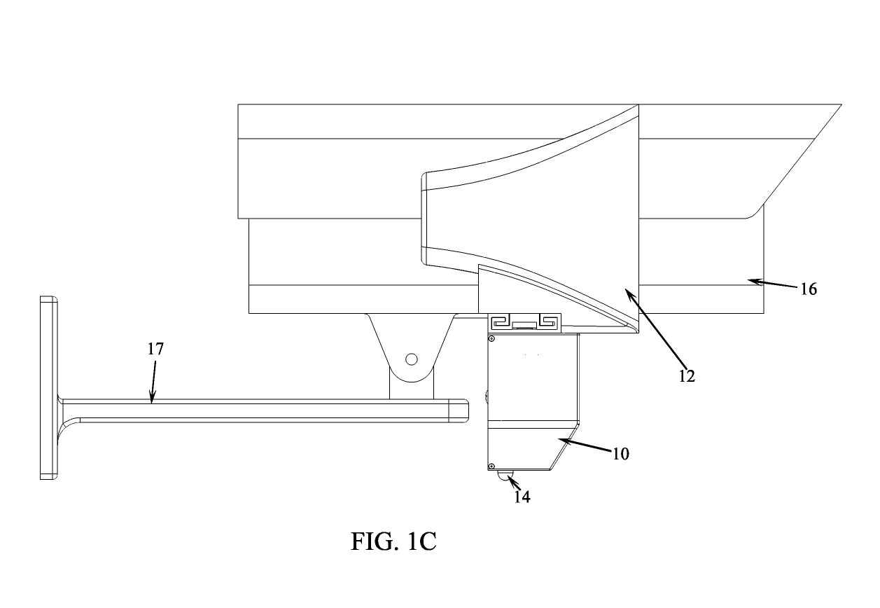

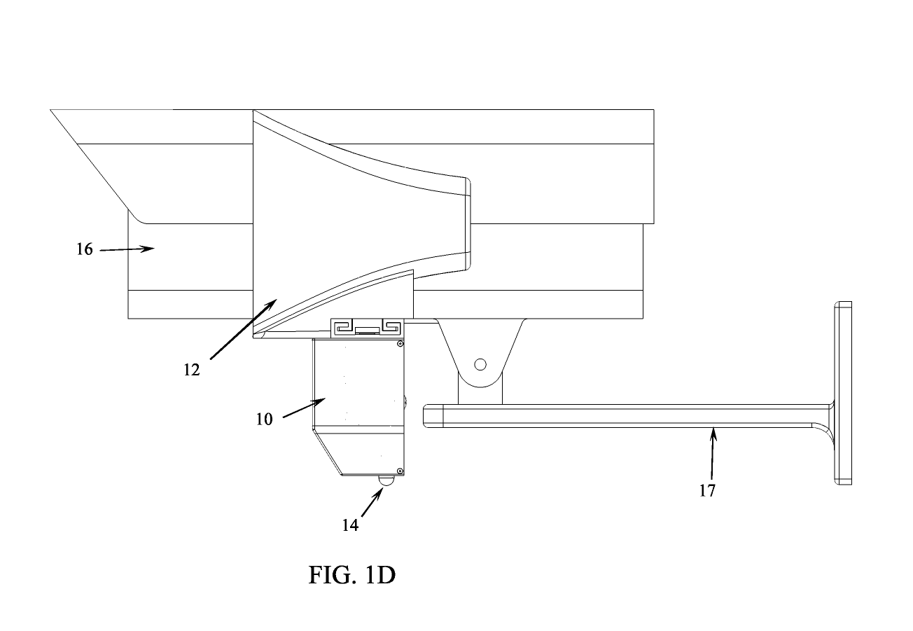

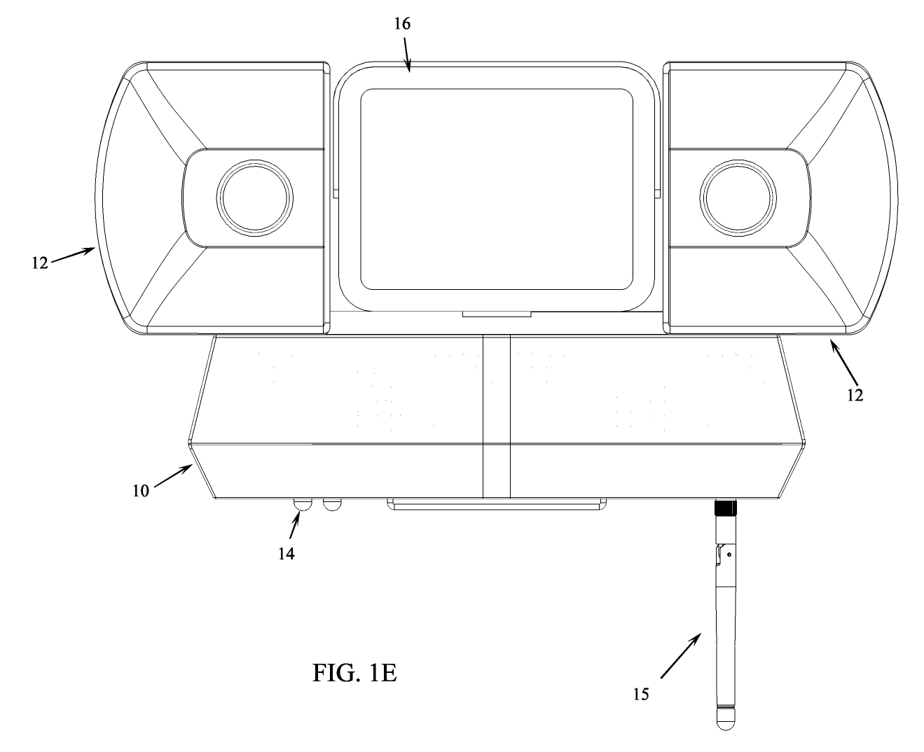

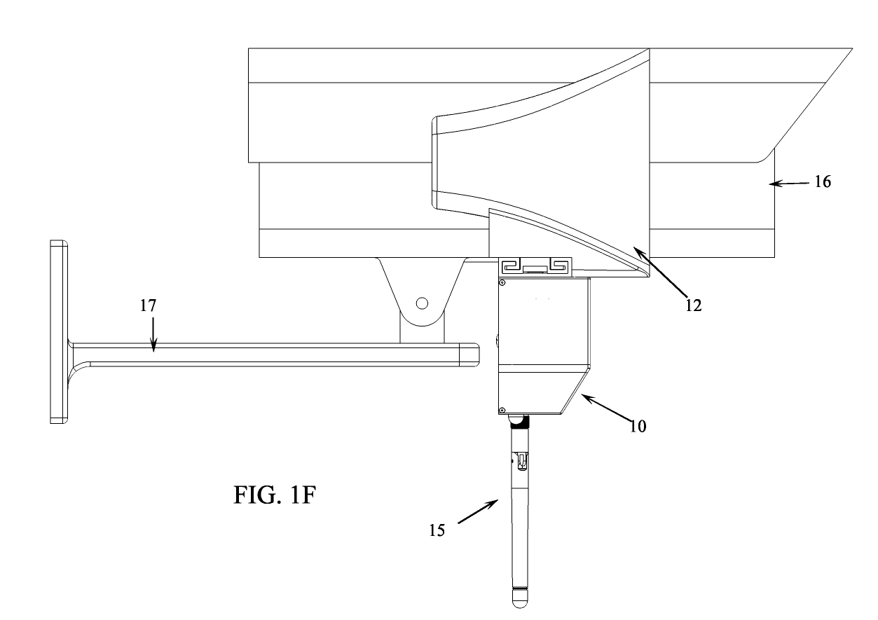

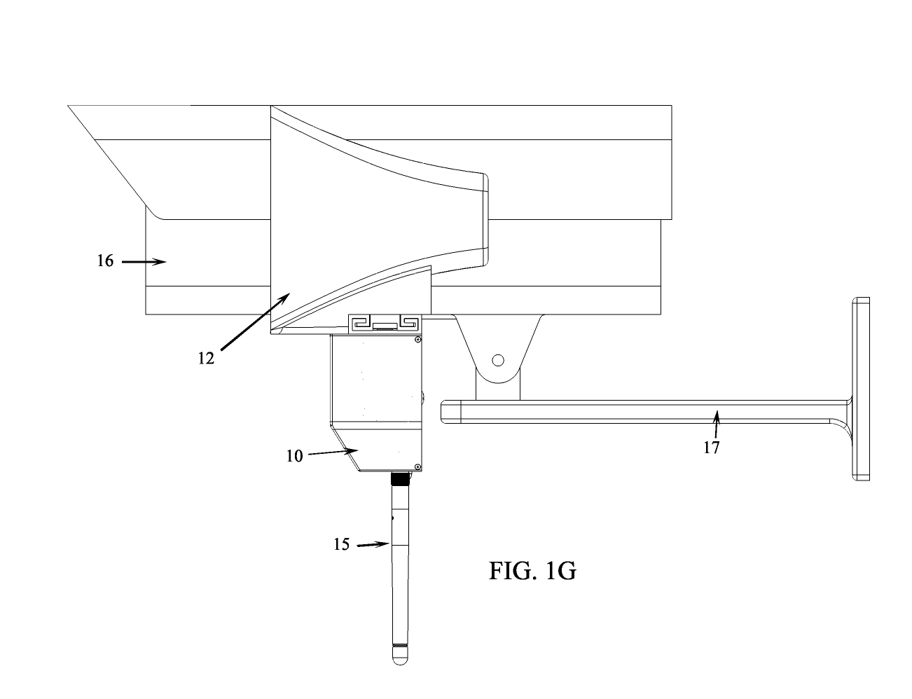

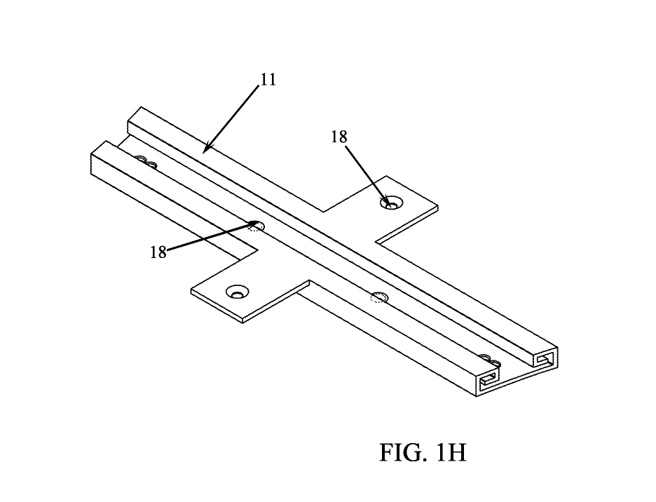

Turning to FIG. 1A, an exemplary embodiment of a hazard warning apparatus is shown. The hazard warning apparatus of FIG. 1A includes an illumination and control unit 10, an illumination and control unit mounting component 11, a pair of audio units 12 and a pair of audio unit mounting components 13. While two audio units 12 are shown, embodiments of the present invention could be comprised of any number of audio units, including a single audio unit. Each of the illumination and control unit 10 and audio units 12 are communicatively and/or operably connected such that transmission between the units is possible. Transmission between the units may include data, power, audio or any combination thereof and may be accomplished from any number of transmission means, including, but not limited to, wired and wireless communications means.

According to an embodiment of the present invention, an audio unit 12 may be a component configured to provide audible alerts to those in the vicinity of the apparatus. Appropriate audio units include, but are not limited to, speakers, horns, buzzers, sirens, or any combination thereof. In a preferred embodiment, the audio unit is a speaker capable of audio reproduction in the form of sound and voice data. The audio unit 12 is configured to be communicatively connected to the illumination and control unit 10 via one or more wired or wireless communication means.

Although the embodiments shown in the figures show an audio unit 12 shaped in a format similar to a loudspeaker, one of ordinary skill in the art would appreciate that the audio unit 12 could be any shape or size. Embodiments of the present invention are contemplated for use with audio units 12 shaped in any appropriate shape or size, including standard circular, oval, rectangular and square speaker shapes and may include any number of speaker types (e.g., tweeters, mid-range, subwoofer, horn), styles or designs.

According to an embodiment of the present invention, the illumination and control unit 10 may be comprised of one or more illumination sources, one or more power sources (e.g. Alternating Current (AC), Direct Current (DC), Power Over Ethernet (POE)), one or more communications means and one or more control elements. In a preferred embodiment, the illumination and control unit 10 is configured to receive data from a connected hazard or security system and affect perceptible hazard alerts to those in the vicinity of the apparatus based on the data received from the connected system.

According to an embodiment of the present invention, the illumination sources may be one or more light sources capable of providing light in a spectrum visible to individuals. In preferred embodiments, the illumination source is capable of providing illumination in recognizable patterns or symbols, such that viewers of the illumination are provided with information relative to a hazard or otherwise associated with the hazard, such as the provision of an appropriate exit route based on the location or type of hazard.

According to an embodiment of the present invention, the control unit portion of the illumination and control unit 10 is configured to provide data communication and processing in association with the connected security or hazard system in order to control the audio unit(s) 12 and illumination sources. The control unit may operate as a standalone component in a system such that data received is processed internally and alerts are provided based on the internally processed data. In other embodiments, the control unit is configured to work as part of a hazard detection, hazard communication or security system and utilizes data provided by the system to provide alerts based on system provided information. In embodiments where a hazard or security system provides data to the control unit, the control unit may provide an alert solely based on the data provided or the control unit may provide further processing and provide an alert based on the data provided and as further processed by the control unit.

In certain embodiments, the control unit of the illumination and control unit 10 may be built into one or more of the audio units 12 and communicatively connected to an illumination unit. In these embodiments, command and control functions are processed in the audio unit as opposed to the illumination unit. The illumination unit would then receive information and/or power from the audio unit. One of ordinary skill in the art would appreciate that there are numerous configurations for the location of the control unit and for transmission of power, data and other communications between the various components of the system.

According to an embodiment of the present invention, the illumination and control mounting unit 11 and audio mounting units 13 are configured to attach the hazard warning apparatus to a fixed position. In preferred embodiments, the illumination and control mounting unit 11 and audio mounting units 13 are configured to be affixed to an existing security camera (See FIGS. 1B-1G). In other embodiments, the illumination and control mounting unit 11 and audio mounting units 13 may be configured to be mounted to any appropriate surface, such as walls, door frames, ceilings, floors or any other fixed point or position. One of ordinary skill in the art would appreciate that there are numerous methods and locations possible for mounting the hazard warning apparatus, and embodiments of the present invention are configured for use with mounting methods and locations appropriate for utilization of the device.

Turning now to FIGS. 1B-1D, an embodiment of a hazard warning apparatus, in accordance with an embodiment of the present invention is shown. In this embodiment, the hazard warning apparatus is mounted to a standard security camera 16. An illumination and control unit 10 is mounted below the security camera 16, with an audio unit 12 mounted to each side of the security camera 16. Indicator lights 14 can be seen on the bottom of the illumination and control unit 10. The entire assembly is mounted to a standard security camera wall mounting frame 17.

Turning now to FIGS. 1E-1G, an embodiment of a hazard warning apparatus, in accordance with an embodiment of the present invention is shown. In this embodiment, the hazard warning apparatus is mounted to a standard security camera 16. An illumination and control unit 10 is mounted below the security camera 16, with an audio unit 12 mounted to each side of the security camera 16. Indicator lights 14 can be seen on the bottom of the illumination and control unit 10. Further, an antenna 15 is shown, which works in conjunction with one or more wireless communications means (e.g., WiFi, BLUETOOTH, cellular) in order to provide extended range and clarity to the wireless communications means. The entire assembly is mounted to a standard security camera wall mounting frame 17.

Turning now to FIG. 1H, is a perspective view of an illumination and control unit mounting component, in accordance with an embodiment of the present invention is shown. In this embodiment, an illumination and control unit mounting component 11 is shown with mounting holes 18 configured to receive one or more mounting means. Mounting means include, but are not limited to, screws, nails, bolts, mounting hardware or any combination thereof. One of ordinary skill in the art would appreciate that there are numerous types of mounting means that could be utilized with embodiments of the present invention, and embodiments of the present invention are contemplated with any appropriate type of mounting means. Further, while a specific number of mounting holes 18 are shown, one of ordinary skill in the art would appreciate that an illumination and control unit mounting component 11 may include any number of mounting holes 18.

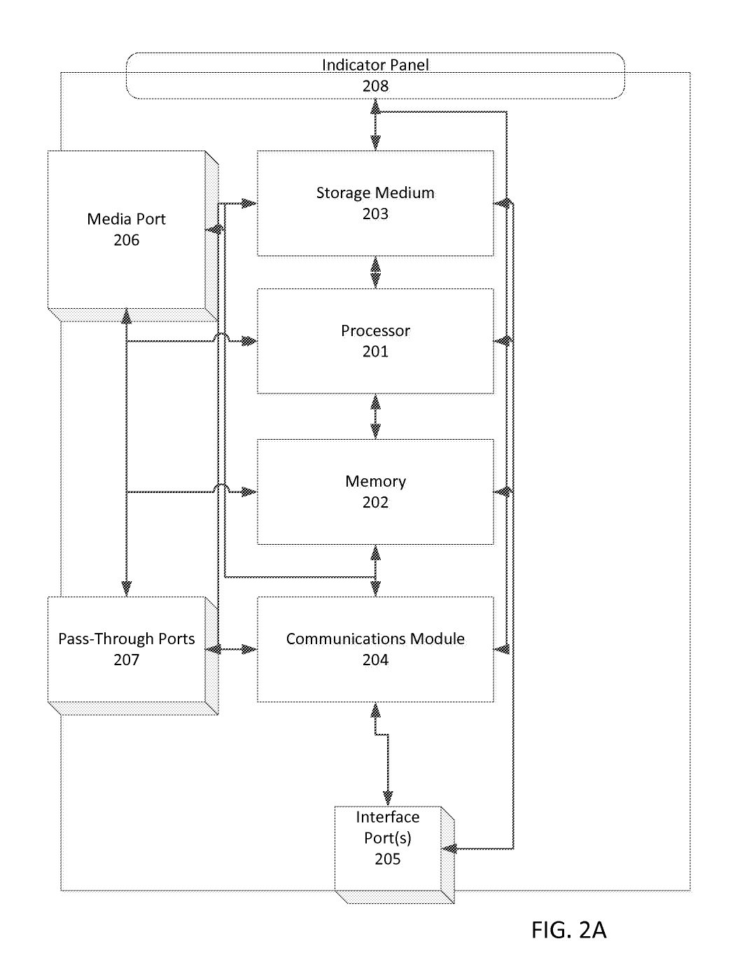

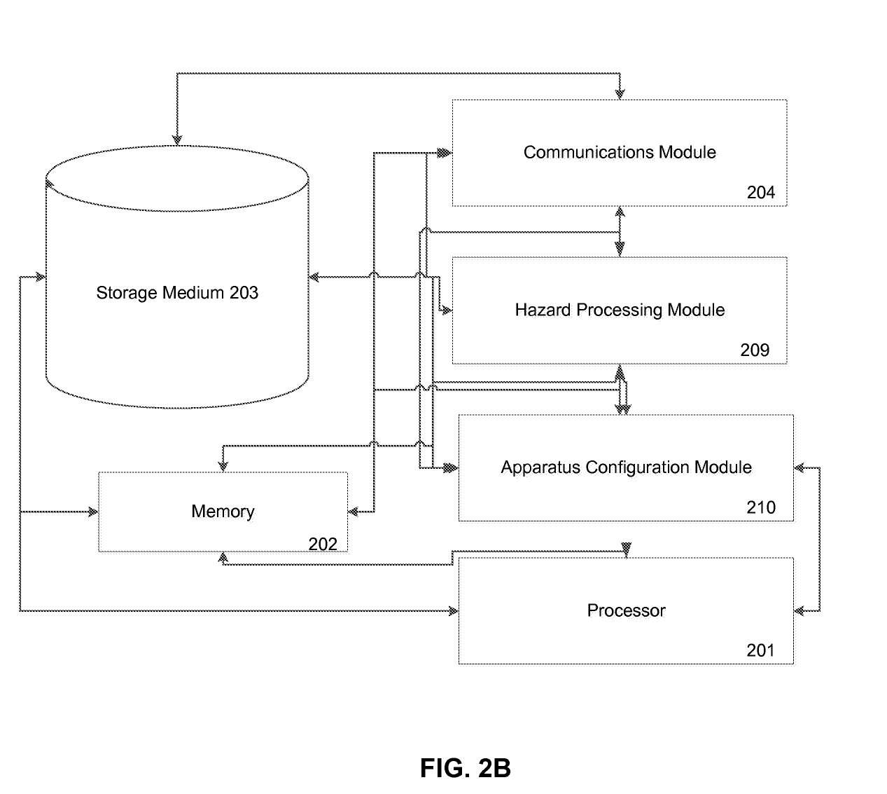

Turning now to FIG. 2A, an exemplary embodiment of a control unit is shown, in accordance with an embodiment of the present invention. In this embodiment, the control unit is comprised of a processor (e.g., processing means, central processing unit (CPU), accelerated processing unit (APU), microcontroller) 201, a memory (e.g., cache memory, random access memory (RAM), read only memory (ROM)) 202, a storage medium (e.g., solid state drive, flash memory, hard disk drive) 203, one or more communications modules 204, one or more interface ports 205, one or more media ports 206, one or more pass-through ports 207 and an indicator panel 208. While FIG. 2A shows a variety of components, one of ordinary skill in the art would appreciate that additional or fewer components could be utilized, and embodiments of the present invention are contemplated for use with any appropriate set of components.

According to an embodiment of the present invention, the communications means of the system may be, for instance, any means for communicating data, voice or audio communications over one or more networks or to one or more peripheral devices or components attached to the apparatus or related systems. Appropriate communications means may include, but are not limited to, wireless connections, wired connections, cellular connections, data port connections, BLUETOOTH connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

In a preferred embodiment of the present invention, the computing devices utilized will incorporate one or more interface ports for use and interaction with the system. Interface ports 205 may include, but are not limited to universal serial bus (USB) ports, audio signal ports (e.g., RCA ports, 3.5 mm audio ports, ¼″ audio ports), digital i/o ports, component input ports HDMI ports, serial ports, parallel ports, proprietary data and/or audio ports, Ethernet ports, fiber-optic ports, general purpose input/output (GPIO) ports, or any combination thereof. One of ordinary skill in the art would appreciate that there are numerous types of interface ports that could be utilized with embodiments of the present invention, and embodiments of the present invention are contemplated for use with any appropriate number and types of interface ports.

In certain embodiments, the interface ports 205 may work in conjunction with one or more pass-through ports 207 to allow for data or other communications to be passed into the apparatus through the interface port(s) 205 and passed back out and onto other components of the apparatus or system via pass-through port(s) 207. For instance, where the apparatus is connected to or associated with a security camera, the apparatus could receive video data via one or more video interface ports and pass the video data through the apparatus and out via a pass-through port. The apparatus may be configured to utilize the pass-through data received from the interface port and transmitted through the pass-through port.

In certain embodiments, the pass-through port 207 could be a different communications type from the interface port 205 receiving the data to be passed through. For instance, in certain embodiments, the interface port 205 could receive standard security camera feeds through video inputs (e.g., RCA, HDMI) and the pass-through port 207 could be configured to pass the video input out via a different communications means (e.g., WiFi, BLUETOOTH). In these embodiments, processing components of the apparatus may be utilized to first process and/or convert the data received (e.g., encode video data to appropriate format, provide compression) or otherwise prepare the data for transmission via the separate pass-through port 207. One of ordinary skill in the art would appreciate that there are numerous methods for processing and transmitting data via a pass-through port, and embodiments of the present invention are contemplated for use with any appropriate method for processing and transmitting such data.

According to an embodiment of the present invention, the media port 206 is configured to receive one or more media formats and utilize information/data stored on the media format for use in the system. Media ports include, but are not limited to, secure digital (SD) ports, micro-SD ports, mini-SD ports, USB ports, compact-disc (CD) drives, digital video disk (DVD) drives, Blu-Ray drives, or any combination thereof. One of ordinary skill in the art would appreciate that there are numerous types of media ports that could be utilized with embodiments of the present invention and embodiments of the present invention are contemplated for use with any appropriate media port type.

Media inserted into a media port is generally configured to provide data to a control unit for use in provision of alerts. For instance, media may contain audio data or pattern data for the illumination sources with respect to various hazard or security breach types. This allows for the control unit to be updated via media inserted into the system. In other embodiments, data related to updating the control unit may be provided via one or more data connections, such as wired or wireless data communication means connected to one or more networks.

According to an embodiment of the present invention, the indicator panel 208 is provided via one or more indicator lights or other visually perceptible means extruding onto an exterior surface of the apparatus. The indicator panel is configured to allow users or operators of the apparatus to view certain current activity with respect to the apparatus. Indicator lights may show certain status events of the apparatus, such as a green light for powered and everything is OK, a flashing red indicator light for an error, a flashing yellow indicator light when one or more actions is occurring in the apparatus (e.g., processing of data, reading/writing to a storage medium). One of ordinary skill in the art would appreciate that there are numerous uses and visual indications that could be utilized in conjunction with the indicator panel, and embodiments of the present invention are contemplated for use with any such visual indications and usages.

Turning to FIG. 2B, according to an embodiment of the present invention, a hazard warning apparatus may be comprised of one or more communications modules 204, one or more storage means 203, a processor 201, memory 202, a hazard processing module 209 and an apparatus configuration module 210. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the hazard processing module 209 is configured to interpret incoming data received from any of the interface ports or media ports and generate an alert based on the incoming data. Hazard data interpretation and alert generation may occur on a variety of criteria. For instance, in certain embodiments, the apparatus is configured to receive hazard alerts from a remote hazard detection and/or communication system. The apparatus, via the hazard processing module 209 working in conjunction with other components of the system, will interpret the hazard and retrieve audio data and/or illumination data stored on the storage medium 203 (or alternatively, stored on media inserted into the media port 206). Audio data is decoded via the processor 201, amplified by an onboard amplifier and transmitted to the audio units as directed by the processor 201. Similarly, illumination data is processed by the processor 201 and transmitted via the illumination sources.

The illumination data may be presented in a variety of visually cognizable manners, referred to herein as illumination patterns. Illumination patterns may be comprised of various colors, patterns and effects generated to create visual stimuli that can engage individuals nearby and provide guidance or direction to those individuals. Illumination patterns may include, but are not limited to, flashing of lights in the illumination sources in specific patterns, creating visual signals (e.g., arrows, stop signals, color cues) to guide viewers along an evacuation path, generation of textual cues (e.g., “stop”, “alarm”, “exit”, “caution”, “evacuate”, “fire”, “intruder”) for use in providing hazard warning or other information to viewers, or any combination thereof. One of ordinary skill in the art would appreciate that there are numerous types of illumination patterns that could be utilized with embodiments of the present invention, and embodiments of the present invention are contemplated for use with any appropriate illumination pattern. Illumination pattern information may be stored on the storage medium 203, provided via media in the media port 206, provided remotely via data received from the communications module 204, any interface port 205, or any combination thereof. The illumination pattern information may be retrieved and processed by the processor 201 which controls the illumination sources.

In certain embodiments of the present invention, the illumination patterns may be provided by the illumination source in non-hazard situations as well. Illumination patterns for non-hazard situations include routing of individuals with hearing impairments during non-hazard situations. For instance, schools for deaf or hearing impaired children could utilize illumination patterns to guide children to bus exit routes or other communal gathering areas (e.g., gymnasium, auditorium) or other specific points (e.g., bathrooms). One of ordinary skill in the art would appreciate that there are numerous types of non-hazard situations that illumination patterns could be used with, and embodiments of the present invention are contemplated for use with illumination patterns for any appropriate non-hazard situation.

As noted above, the audio data may be stored on the storage medium 203 (or alternatively, stored on media inserted into the media port 206). Audio data is decoded via the processor 201, amplified by an onboard amplifier and transmitted to the audio units as directed by the processor 201. In other embodiments, the audio data may be provided to the apparatus via the communications module 204, any interface port 205, or any combination thereof. Audio data provided by remote sources, such as audio data received from the interface ports 205 or communications module 204 may be processed by the processor 201, amplified by an onboard amplifier and transmitted to the audio units as directed by the processor 201.

According to an embodiment of the present invention, in situations where the audio data and/or illumination pattern information is provided by a remote system (collectively, “hazard response data”), the collective hazard response data may be utilized by the apparatus to provide real-time or near real-time hazard alerts. For instance, the audio data of the hazard response data may include real-time audio, such as audio information about the specific hazard behind the alert or information about how to react to the particular hazard (e.g., “stay low and breath through a wet cloth” where the hazard includes fire/smoke). Similarly, the illumination pattern information of the hazard response data may provide hazard specific visual information, including, but not limited to, exit paths, visual information about the specific hazard or information about what actions viewers should take (e.g., “shelter in place” where the hazard involves an active shooter). In preferred embodiments, the hazard response data provides compatible audio and illumination stimuli for providing appropriate cues and information to all viewers, thereby allowing for the apparatus to assist those with disabilities to one or more senses (e.g., hearing impaired, visually impaired).

According to an embodiment of the present invention, hazard response data and/or hazard data may be provided to the apparatus via one or more remote components of a hazard detection and/or communication system, such as (i) via a remote computing device operating with software configured to interact with and communicate with the apparatus, (ii) one or more sensors for detecting hazards, (iii) security cameras, (iv) via the media port 206, (v) via switches, or (vi) any combination thereof.

According to an embodiment of the present invention, hazard response data and/or hazard data provided to the apparatus via a remote computing device may allow an operator of the remote computing device to provide ad-hoc hazard response data to the apparatus, such as voice data from the operator of the remote computing device. In other embodiments, the operator of the remote computing device may utilize and provide any number of pre-configured hazard response data to the apparatus (e.g., pre-recorded messages selected by the operator).

According to an embodiment of the present invention, where sensors are providing the hazard response data and/or hazard data, the specific sensor type may dictate what is received and processed by the apparatus. Sensors are generally connected to one or more interface ports 205 or communications modules 204 of the apparatus and may include, but are not limited to, motion sensors, smoke detectors, carbon monoxide sensors, glass break sensors, earthquake sensors, door sensors, window sensors, hall effect sensors, heat sensors, home security systems, or any combination thereof. In certain embodiments, the sensors will only provide hazard data, such as the actual detection of a hazard based on the sensor type (e.g., heat sensor is tripped and provides the apparatus information that the heat sensor has been tripped).

In certain embodiments, the sensors may be configured to provide hazard response data as well as or in lieu of hazard data. For instance, a heat sensor that is configured to work in conjunction with the apparatus may provide hazard response data to the apparatus as opposed to requiring the apparatus to utilize stored hazard response data. Advantageously, the apparatus does not need to store locally the hazard response data. Further, the hazard response data from the sensor could provide specifics about the hazard detected and/or location of the hazard. For instance, an apparatus could be connected to a plurality of heat sensors whereby when a specific heat sensor is tripped, the heat sensor could provide hazard response data to the apparatus, wherein the hazard response data identifies location of the heat sensor (e.g., via pre-programmed location based on Internet Protocol (IP) address, via location means incorporated into the sensor such as global positioning system (GPS) means) and/or a severity of the hazard (e.g., temperature exceeds 400 degrees Fahrenheit, temperature exceeds 800 degrees Fahrenheit). In this manner, those proximate to the apparatus can be provided specific information relative to the hazard.

Further, in situations where the sensor provides location information relative to the hazard, the apparatus could generate an exit path or other illumination pattern information based on the location of the sensor. In this manner, the apparatus is not required to receive specific illumination pattern information from a remote source as it can generate its own illumination pattern information based on hazard response data and/or hazard data provided to the apparatus.

According to an embodiment of the present invention, the apparatus may be activated by one or more switches. Switches may be integrated into the apparatus or connected to the apparatus via one or more interface ports 205. Switches may allow those in the vicinity of the apparatus to manually engage a hazard alert. In certain cases, a single switch may be provided. In other embodiments, a plurality of switches may be provided, with each switch representing a different hazard or alert. In cases where the switches are connected via an interface port 205, the switches may be configured to provide hazard response data similar to sensors connected in the same fashion. For instance, a switch may provide hazard response data so that the audio data and illumination pattern information does not need to be stored in the apparatus or the switch may be located remotely from the apparatus and when triggered, the apparatus may use the location to generate appropriate hazard response data (similar to remote sensors described above).

In certain embodiments, switches may be provided that allow those in the vicinity to trip the switch of an apparatus during an ongoing hazard alert to identify the location of the threat/hazard. This may allow a central unit to know that there are individuals trapped or are otherwise located near a specific apparatus.

According to an embodiment of the present invention, the apparatus may be comprised of one or more power sources for provision of power to the apparatus and its components. Power sources may include, but are not limited to wired power sources and battery power or other backup power systems. Wired power sources include, but are not limited to Power Over Ethernet (POE), Alternating Current (AC), Direct Current (DC), or any combination thereof. Preferred embodiments of the present invention include one or more battery or other backup power systems for the provision of power in case of the loss of a standard power source such as the wired power source. In these preferred embodiments, the wired power source may recharge the battery or backup power systems during regular operation for use in the case of the loss of the wired power source. In certain embodiments, renewable energy sources may be utilized, such as solar panels attached to or integrated with the apparatus for provision of power without requiring a wired power source. Similar to those embodiments with wired power sources, a renewable energy source may recharge a battery or other backup power system for use when the renewable energy source is unavailable.

Apparatuses Arranged in a System

According to an embodiment of the present invention, multiple hazard warning apparatuses may be linked and work in conjunction with one another in order to provide a hazard warning system. In general, the linking may occur via a central or distributed computing model. In a central computing model, a remote computing device, such as a computer, laptop, server or central security system may monitor and control or otherwise receive from and provide data to and among a plurality of hazard warning apparatuses. In a distributed computing model, a plurality of hazard warning apparatuses are linked (e.g., via IP addressing) and work in conjunction with one another to provide and generate hazard alerts as a collective. One of ordinary skill in the art would appreciate that there are numerous methods for configuring and managing a system of hazard warning apparatuses, and embodiments of the present invention are contemplated for use with any appropriate method for configuring and managing such systems.

According to an embodiment of the present invention, when linked the apparatuses are able to provide an additional feature set that enhances the usefulness of the apparatuses. One major advantage of having a plurality of linked apparatuses is that, in conjunction with identifying each apparatus by a specific location, whether determined by the apparatus via a location means such as a GPS unit or assigned during configuration of the system (e.g., user identifies location of each apparatus via a configuration module), the system can provide specific hazard response data to each apparatus in order to effect enhanced rescue or recovery features.

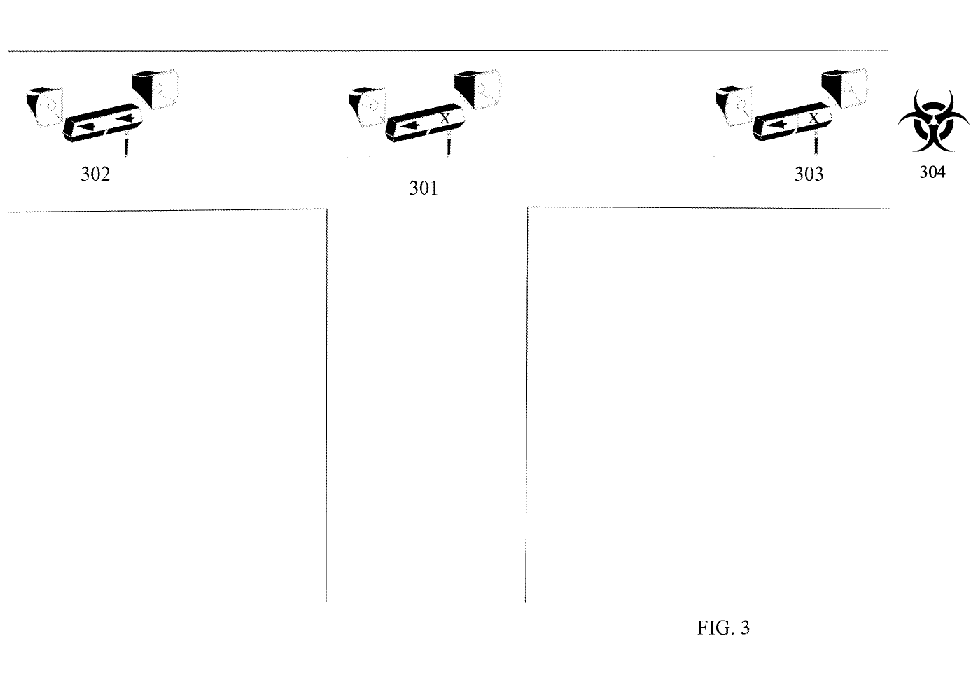

Turning to FIG. 3, an exemplary embodiment of a linked system of hazard warning apparatuses is shown, in accordance with an embodiment of the present invention. In FIG. 3, three hazard warning apparatuses 301, 302, 303 are linked in a system for providing hazard alerts. In this diagram, a hazard (represented by the biohazard symbol) 304 is detected by the system and is occurring down a pathway to the right of hazard warning apparatus 303. Upon detecting the hazard 304, the system generates an appropriate evacuation route based on known location of the hazard 304 and locations of exits. Each hazard warning apparatus 301, 302, 303 provides visual and audio alerts that direct the users away from the hazard 304 and out of the building or other hazard area. As shown, directions can be provided by illuminated signals provided by the hazard warning apparatuses 301, 302, 303. Further, audio signals may be utilized to provide directional information to those with visual disabilities or where visibility is otherwise limited (e.g., smoke filled area). Audio signals may be provided in sequence directing user to follow the signal in order. For instance, a first audio signal at 303, a second audio signal at 301, and a third audio signal at 302 would identify to those capable of hearing the audio signal that they should follow the sequenced audio towards the last initiated audio signal as the first audio signal indicates a location of a hazard 304. In other embodiments, audio signals may be different for each apparatus (e.g., hazard warning apparatus 303 audio signal comprising “Warning” while audio signal from hazard warning apparatus 302 comprising “Safe”).

### Exemplary Embodiments

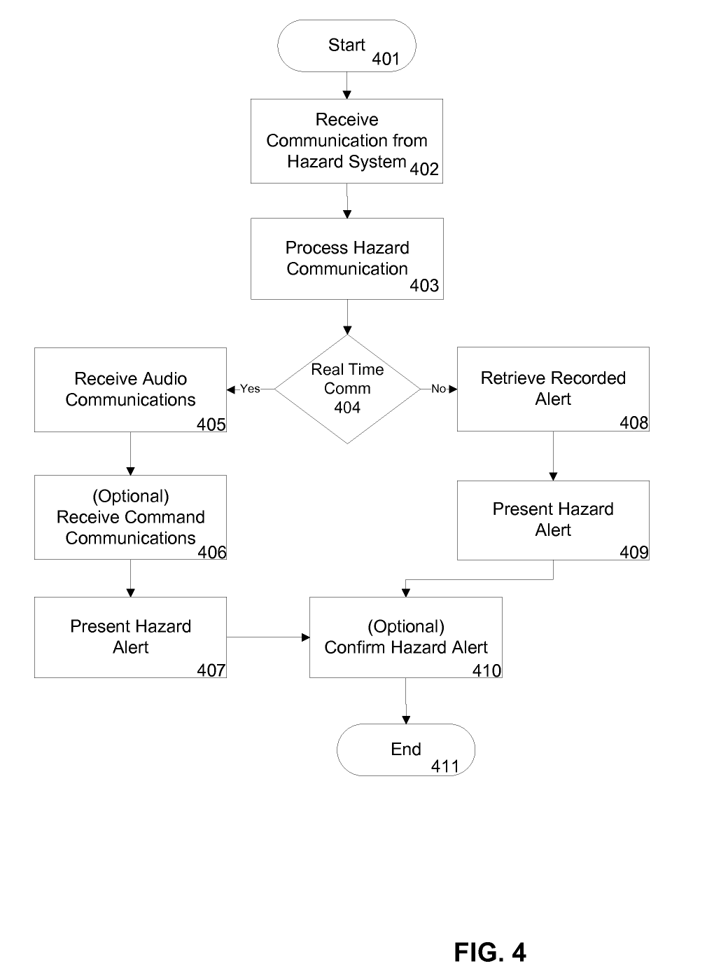

Turning now to FIG. 4, an exemplary method for providing hazard warning signals through a hazard warning apparatus is shown. The process starts at Step 401 with the detection of a hazard. At step 402, the hazard warning apparatus receiving a communication from a hazard system (whether a standalone system or a sensor attached to the hazard warning apparatus via an interface port or other means). At step 403, the processing components of the hazard warning apparatus process the hazard communication.

At step 404, the hazard warning apparatus determines whether the hazard response data involves real time hazard response data or if the hazard response data is to be retrieved from locally stored hazard response data.

If the hazard response data is to include real-time hazard response data, the process moves to step 405, where the apparatus begins to receive and process real-time hazard response data. The hazard response data may also optionally include real-time command communications related to control of the illumination source which are processed at step 406. At step 407, the hazard alert is provided by one or more of the audio units and/or illumination sources.

If the hazard response data does not include real-time hazard response data, the process proceeds to step 408 and hazard response data is retrieved from locally stored data. Once retrieved, the hazard response data is processed and presented at step 409.

In either case, the hazard warning apparatus may optionally be configured to confirm to a central system or other remote system that the alert has been presented (step 410). This can be done to alert authorities or otherwise provide hazard information to the remote or central system for further processing. In any event, the process terminates at this point (step 411).

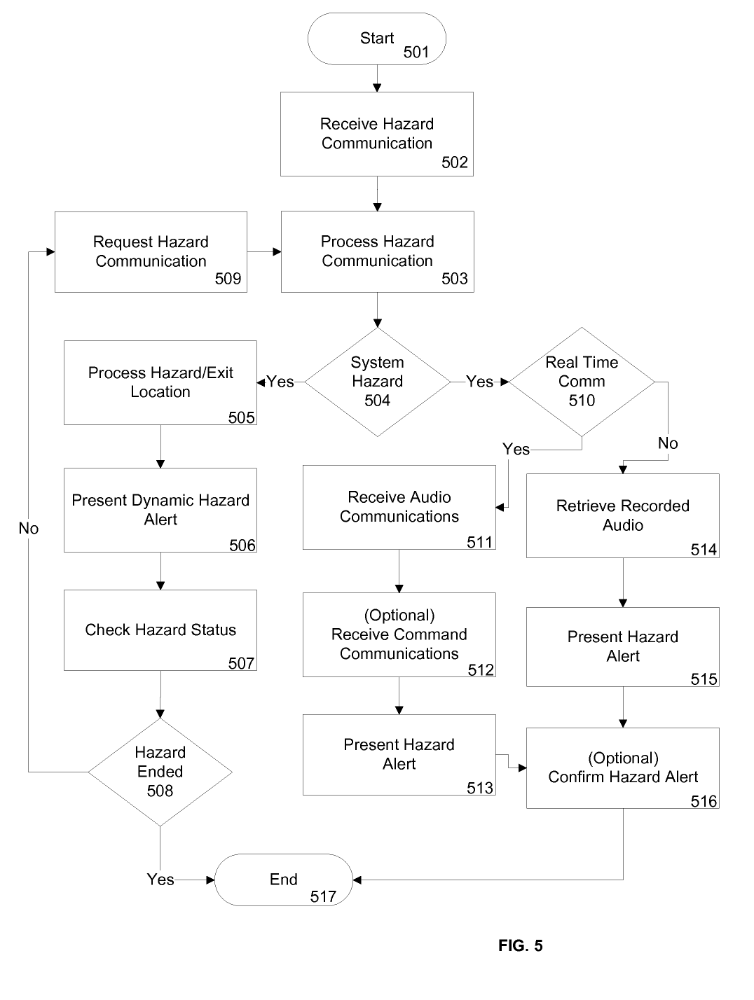

Turning now to FIG. 5, a method of operation of a system of linked hazard warning apparatuses is shown from the viewpoint of a single hazard warning apparatus. The process starts with the hazard being detected at step 501. At step 502, the hazard warning apparatus receives a hazard communication. At step 503, the hazard communication is processed by the hazard warning apparatus and it is determined whether the hazard is a system wide hazard or a local hazard (step 504).

If the hazard is a system wide hazard, the system processes a hazard location and/or an exit location (step 505). This can be done in the manner detailed above herein. For instance, the apparatus may generate these determinations on its own or the information may be provided to it via the system.

At step 506, the apparatus presents the hazard alert in a manner as directed by the system. This could include real-time hazard response data, illumination and/or audio providing exit information or other hazard related information.

At step 507, the apparatus may be configured to check or wait for a signal from the system determining that a hazard has ended. A determination is made at step 508 and if a hazard is ongoing, the apparatus may request additional or more current hazard information at step 509 at which the processes loops back to step 503. If the hazard has ended, the system may optionally confirm the hazard alert at step 516 and the process will terminate at step 517.

At step 510, the hazard warning apparatus determines whether the hazard response data involves real time hazard response data or if the hazard response data is to be retrieved from locally stored hazard response data.

If the hazard response data is to include real-time hazard response data, the process moves to step 511, where the apparatus begins to receive and process real-time hazard response data. The hazard response data may also optionally include real-time command communications related to control of the illumination source which are processed at step 512. At step 513, the hazard alert is provided by one or more of the audio units and/or illumination sources.

If the hazard response data does not include real-time hazard response data, the process proceeds to step 514 and hazard response data is retrieved from locally stored data. Once retrieved, the hazard response data is processed and presented at step 515.

In either case, the hazard warning apparatus may optionally be configured to confirm to a central system or other remote system that the alert has been presented (step 516). This can be done to alert authorities or otherwise provide hazard information to the remote or central system for further processing. In any event, the process terminates at this point (step 517).

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, the apparatus and any remote computing system or other computerized system utilized in conjunction with the systems and methods described herein may include a computer program that may consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions and processing instructions may include computer executable code. A variety of languages for expressing computer program instructions are possible, including without limitation C, C++, C#, Java, JavaScript, assembly language, Lisp, HTML, .NET and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A hazard warning apparatus comprising:
an illumination component;
one or more audio units; and
a control element comprising a processing means, a memory a storage medium, a communications module, one or more interface ports and one or more media ports,
wherein said illumination component, said one or more audio units and said control element are operably connected and are configured to:
receive hazard data from one or more of said one or more interface ports and said communications module;
process said hazard data;
generate hazard response data based on said hazard data; and
generate a hazard alert via said illumination component and said one or more audio units.

2. The hazard warning apparatus of claim 1, wherein said illumination component, said one or more audio units and said control element are further configured to:
receive real-time hazard response data via one or more of said one or more interface ports and said communications module.

3. The hazard warning apparatus of claim 2, wherein said real-time hazard response data is processed and a real-time hazard alert is generated via said illumination component and said one or more audio units.

4. The hazard warning apparatus of claim 1, wherein said illumination component is comprised of a plurality of illumination sources.

5. The hazard warning apparatus of claim 1, wherein said hazard alert comprises a visually perceptible illumination of an appropriate exit pathway via said illumination component.

6. The hazard warning apparatus of claim 1, wherein said hazard alert comprises an audibly perceptible sound defining an exit pathway via said one or more audio units.

7. The hazard warning apparatus of claim 1, further comprising one or more sensors, wherein each of said one or more sensors is operably connected to said control element via one or more of said one or more interface ports and communications module.

8. The hazard warning apparatus of claim 1, wherein said communications module is one or more communication means selected from the group comprising WIFI modules, Bluetooth modules, Ethernet modules, cellular data modules, near field communication modules and radio frequency communication modules.

9. The hazard warning apparatus of claim 1, further comprising one or more switches, wherein said switches are operably connected to said control component and configured to allow for the manual generation of a hazard alert.

10. The hazard warning apparatus of claim 1, wherein the apparatus is further configured to:
receive, via one or more of said communications module and one or more of said one or more interface ports, hazard information from one or more of a security camera, a hazard detection system, or a hazard communication system; and
utilize said hazard information to provide one or more of an audio or visual hazard alert.

11. A method for generating hazard alerts via a hazard warning apparatus, the method comprising the steps of:
receiving hazard data at said hazard warning apparatus via one or more of an interface port and a communications module;
processing said hazard data via a control element;
generating hazard response data at said control element based on said hazard data; and
generating a hazard alert via an illumination component and one or more audio units operably connected to said control element.

12. The method of claim 11, further comprising the step of receiving real-time hazard response data via one or more of said interface port and said communications module.

13. The method of claim 12, further comprising the steps of:
processing said real-time hazard response data; and
providing a real-time hazard alert via said illumination component and said one or more audio units.

14. The method of claim 11, wherein said illumination component is comprised of a plurality of illumination sources.

15. The method of claim 11, wherein said hazard alert comprises a visually perceptible illumination of an appropriate exit pathway via said illumination component.

16. The method of claim 11, wherein said hazard alert comprises an audibly perceptible sound defining an appropriate exit pathway via said one or more audio units.

17. The method of claim 11, further comprising one or more sensors, wherein each of said one or more sensors is operably connected to said control element via one or more of said one or more interface ports and communications module.

18. The method of claim 11, wherein said communications module is one or more communication means selected from the group comprising WiFi modules, Bluetooth modules, Ethernet modules, cellular data modules, near field communication modules and radio frequency communication modules.

19. The method of claim 11, further comprising one or more switches, wherein said switches are operably connected to said control component and configured to allow for the manual generation of a hazard alert.

20. The method of claim 11, further comprising the steps of:
receiving, via one or more of said communications module and said interface port, hazard information from one or more of a security camera, a hazard detection system, or a hazard communication system; and
utilizing said hazard information to provide one or more of an audio or visual hazard alert.
